(19) United States
(12) Patent Application Publication
(10) Pub. No.: US 2026/0162542 A1
(43) Pub. Date: Jun. 11, 2026

(54) METHODS AND SYSTEMS FOR UNMANNED AERIAL VERHICLE ROUTE PLANNING USING DATA INTEGRATION AND RISK ASSESSMENT

(71) Applicant: Airspace Link, Inc., Detroit, MI (US)

(72) Inventors: Daniel Bradshaw, Detroit, MI (US); Tyler Dicks, Detroit, MI (US); Colby Free, Detroit, MI (US)

(21) Appl. No.: 18/969,790

(22) Filed: Dec. 5, 2024

(51) Int. Cl. G08G 5/34; G08G 5/22; G08G 5/23; G08G 5/57; G08G 5/59

(52) U.S. Cl. CPC G08G 5/34; G08G 5/22; G08G 5/23; G08G 5/57; G08G 5/59

(57) ABSTRACT

Methods and systems for optimizing Unmanned Aerial Vehicle (UAV) flight patterns involves retrieving various types of location-based data (e.g., geospatial, population, weather, airspace restrictions, etc.) from third-party databases and normalizing it into a consistent format. This data is then divided into or associated with spatial indices, with each index assigned a risk score based on weighted factors like population density, infrastructure, and environmental conditions. These scores are compiled into surface data, which serves as a detailed risk map for UAV operations. The surface data can be visualized as a heatmap or delivered as a structured dataset, allowing clients to plan safe and efficient UAV routes by avoiding high-risk areas. By integrating this data with real-time information, such as air traffic or weather, UAV flight paths can be dynamically adjusted to minimize risks and ensure optimal navigation through low-risk zones.

### TECHNICAL FIELD

The present disclosure relates to drone navigation systems and methods, specifically to data integration and processing for optimized route planning.

### BACKGROUND

Unmanned Aerial Vehicles (UAVs) are increasingly being used in a variety of sectors, such as delivery, surveillance, and emergency response, among others. This rapid expansion of UAVs has brought with it significant challenges in navigation and route planning. UAVs must navigate complex environments that include urban landscapes, restricted airspaces, and varying weather conditions. These challenges are compounded by the need to ensure safety and compliance with regulatory requirements.

Existing air traffic control infrastructure was not designed to accommodate flights of UAVs at scale. Thus, as flight becomes more accessible and involves an ever-increasing number and types of aircraft, managing controlled airspace and flight routing becomes more challenging, time consuming, and costly.

### BRIEF DESCRIPTION OF THE DRAWINGS

FIG. 1 is a schematic of a system for generating spatially-indexed scores suitable for Unmanned Aerial Vehicle (UAV) applications, according to an embodiment.

FIG. 2 is a block diagram of a computing device configured to perform various actions disclosed herein, according to an embodiment.

FIG. 3 is a block diagram of a processor interacting with memory for performing various models disclosed herein, according to an embodiment.

FIGS. 4-7 are various examples of user interfaces suitable for UAV applications, according to embodiments.

FIG. 8 is a flow chart of a method for generating spatially-indexed scores and surface data suitable for UAV applications, according to an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In recent years, the use of Unmanned Aerial Vehicles (UAVs) has expanded across various industries, including delivery services, surveillance, and infrastructure inspection. The increasing reliance on UAVs necessitates efficient route planning to ensure safe and effective operations. Prior art UAV-management systems are known to create airspace maps by integrating user-specific flight information, authorization status, and real-time flight telemetry, enabling a user to view real-time flight information and modify flight parameters during flight. However, risk analysis in the route planning is not dealt with.

Existing solutions for UAV route planning face several challenges. These systems lack the capability to effectively integrate and process the vast array of data types required for comprehensive risk assessment. For example, suppose it is desired for a UAV to deliver a parcel from location A to location B. The direct path from location A to location B may not be desirable due to high-population areas, public parks, schools, office buildings, concert venues, and the like. If, for example, a drone were to fly close to these areas, not only would noise pollution be an issue but if the UAV were to malfunction and crash land in these areas, it could lead to risk of injury (or worse) with the people on the ground. Prior art systems do not appropriately manage risk in their flight planning tasks, leading to suboptimal route planning.

Therefore, according to various embodiments disclosed herein, methods and systems are disclosed for UAV route planning with integrated risk analysis. In embodiments, as will be disclosed below, the methods and systems generate spatially-indexed scores, with the score relating to a risk associated with a particular region. For example, geospatial data is received and segregated into spatial indices (e.g., regular, evenly-shaped grid cells). The system then receives many forms of third-party data, such as population density data, aviation data, land usage data, zoning data, infrastructure data, building data, and the like. The system normalizes all of this third-party data into a common data type, making it easy to digest and process. This allows the system to assign a score to each spatial index based on this common data type, wherein the scores reflect a weighted risk factor associated with directing a UAV through that spatial index. For example, if a particular group of spatial indices are associated with a school, those spatial indices can be scored to reflect a high risk. If another group of spatial indices are associated with rural farm land, those spatial indices can be scored to reflect a low risk. Surface data packets can be generated based on all of this data, so that a user (or third party) can select a starting point and an ending point, and the surface data can allow the system to generate a planned route for the UAV that would allow the UAV to fly from the starting point to the ending point taking into account the risk associated with the spatial indices along the route. In other words, the route can be planned to go through spatial indices that have a lower risk score.

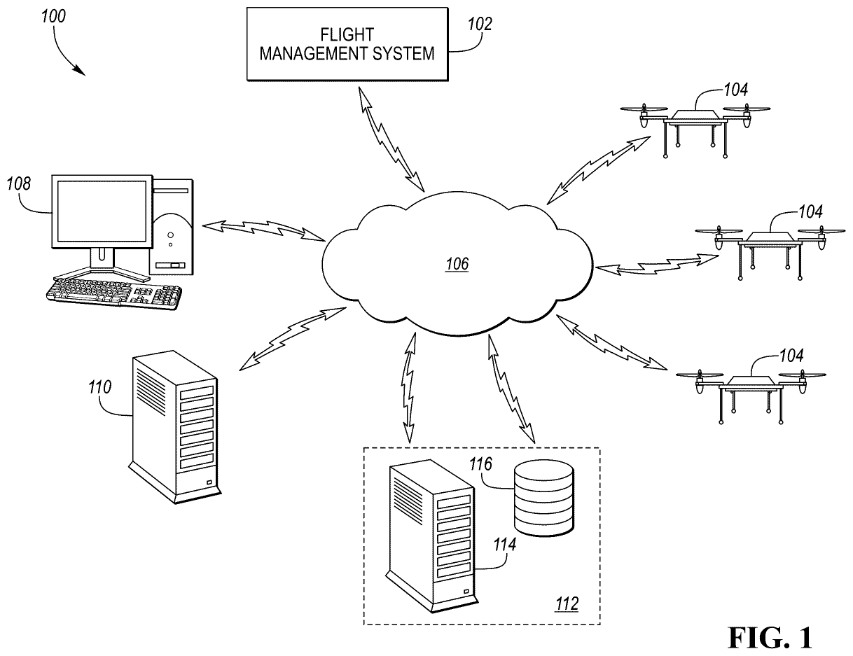

Referring to FIG. 1, Referring to FIG. 1, a schematic diagram of a system 100 for UAV route planning use data integration and risk assessment is illustrated. The system 100 provides the environment in which the methods described herein generally operate.

The system 100 includes a flight management system 102, which serves as the central hub for coordinating various elements involved in UAV operations. This system 102 can, for example, generate planned routes for one or more UAV 104, and transmit those planned routes to the UAV(s) 104 via communication network 106.

The system 100 also includes computing device 108 and a server 110. In some cases, the computing device 108 may be operated by, for example, the UAV operator. In other cases, the computing device 108 may be operated by a third party to generate planned routes for a fleet of UAVs 104. The server 110 may also incorporate the computing device 108 (e.g., processor, memory, and the like described below).

In examples provided herein, the flight management system 102 may be provided, and otherwise operable, on the computing device 108. In other embodiments, the flight management system 102 may be located (or hosted) on the external server 110. In these cases, the communication network 106 can include a wired component which allows for the option of wired communication between the computing device 108 and the external server 110. In some embodiments, communication network 106 may be, for example, one or more of a wireless personal area network such as a BLUETOOTH network, a wireless local area network such as the IEEE 802.11 family of networks, a cellular communication network (e.g., 4G, 5G, etc.), Ethernet or a satellite communication network, or the Internet. The communication network 106 facilitates data transmission between the flight management system 102, UAV 104, computing device 108, and other connected components. This network supports the retrieval of location-based data from third-party databases and the dissemination of processed data to the UAV 104. The communication network 106 ensures seamless connectivity, enabling efficient data flow and coordination among all system components.

The server 110 acts as a repository and processing unit for the flight management system 102. Planned routes can be generated based on the data received and/or stored at the server 110. In embodiments, the server 110 communicates with third parties 112 (e.g., third-party server 114, third-party databases, 116, etc.) via network 106. The third party servers 114 may contain one or more third-party databases 116. The third parties 112 contain many different types of data associated with geographical areas. For example, the third-party servers 114 may contain collected data such as aviation data, population data, land usage data, zoning data, facility data, infrastructure data, natural data, building data, weather data, topographical data, traffic data, environmental data, emergency services data, historical flight data, communication infrastructure data, regulatory data, and the like, all of which are associated with a geographic location. For example, given a particular location, one or more of the third-party servers can supply one or more of these types of data associated with that particular location. Each of these types of data is explained in more detail below.

One or more of the third-party servers 114 may contain geographic data or mapping data, also referred to as geospatial data or Geographic Information System (GIS) data. This data provides detailed information about the Earth's surface, including roads, land boundaries, coordinates, and landmarks. This data can be provided by various sources, such as OpenStreetMap, Google Maps API, or ESRI's ArcGIS. National mapping agencies, like the U.S. Geological Survey (USGS), also offer comprehensive geospatial data. Some commercial providers offer more detailed datasets, including satellite imagery or high-resolution mapping for specific regions. For UAV route planning, this geospatial data is essential for defining the precise starting and ending points of a route, identifying accessible routes, and visualizing the terrain or obstacles. It serves as the foundational map on which other data layers (described below), such as population density or airspace restrictions, can be overlaid to ensure optimal route planning.

One or more of the third-party servers 114 may contain aviation data. This includes information on air traffic, flight paths, no-fly zones, restricted airspaces, and other regulatory flight data. Databases like the FAA's UAS Facility Maps, ADS-B Exchange, or FlightAware provide such data. For the UAV route planning described herein, this data helps avoid conflicts with manned aircraft, restricted airspaces, and ensures compliance with flight regulations, particularly around airports and sensitive areas.

One or more of the third-party servers 114 may contain population data. This refers to the number and distribution of people in different geographic areas, often broken down by density. Census databases such as the U.S. Census Bureau or WorldPop can provide such data. For the UAV route planning described herein, population data can minimize risk by identifying and prioritizing flight routes through less-populated areas, reducing potential harm in case of a crash.

One or more of the third-party servers 114 may contain land usage data. Land use data categorizes how land is utilized, such as residential, commercial, agricultural, or industrial purposes. Databases like OpenStreetMap or local government GIS platforms can offer this data. For the UAV route planning described herein, this information helps UAVs avoid areas where crashes could have significant consequences, such as urban residential areas, while favoring routes over less critical land uses like agriculture or wilderness.

One or more of the third-party servers 114 may contain zoning data. Zoning data outlines the legal land use regulations in specific areas, determining what activities can occur in those regions. This can be available from municipal or regional government databases. For the UAV route planning described herein, understanding zoning helps ensure compliance with local laws and regulations, downgrading zones where UAV operations may be restricted or prohibited, such as industrial zones or parks.

One or more of the third-party servers 114 may contain facility data. Facility data includes the location of critical buildings like hospitals, schools, and government offices. This data can be sourced from local government or commercial geospatial platforms. For the UAV route planning described herein, facility data can help avoid flying over high-risk or sensitive areas where a crash could disrupt essential services or pose significant hazards.

One or more of the third-party servers 114 may contain infrastructure data. Infrastructure data includes the location and identity of roads, bridges, power lines, transportation networks, and the like. GIS platforms or national infrastructure databases like the U.S. Department of Transportation can provide this. For the UAV route planning described herein, this data can help plan routes that avoid vital infrastructure, minimizing risks to transportation systems and power grids in case of an accident.

One or more of the third-party servers 114 may contain natural data. This encompasses information on forests, lakes, mountains, and other natural features. Environmental databases or services like Google Earth Engine or the like can provide this data. UAV route planning can benefit from natural data to identify areas where flight could be challenging due to terrain (e.g., mountainous regions) or where crashes could disrupt sensitive (e.g., protected) ecosystems.

One or more of the third-party servers 114 may contain building data. Building data involves the location, height, and characteristics of structures. This can be available through city planning departments or 3D building models like those in OpenStreetMap or municipal GIS systems. For the UAV route planning described herein, building data can help avoid collisions by flying around or over tall structures, especially in urban areas.

One or more of the third-party servers 114 may contain weather data. Weather data includes current conditions and forecasts for wind, precipitation, visibility, and the like. Sources like the National Oceanic and Atmospheric Administration (NOAA) or commercial providers like The Weather Company can offer this. For the UAV route planning described herein, weather data can help plan routes so that the UAVs avoid adverse conditions like high winds or storms that could jeopardize the UAV's operation.

One or more of the third-party servers 114 may contain topographical data. This data outlines the physical features of the landscape, such as elevation and slopes. Topographical data can be available from the U.S. Geological Survey (USGS) or similar geospatial platforms. The route planning systems described herein can use topographical data to avoid challenging terrain and ensure safe navigation through regions with significant elevation changes.

One or more of the third-party servers 114 may contain traffic data. Traffic data provides real-time and historical information about road traffic volumes and flow, for example. Traffic databases like Google Maps or government transportation agencies can offer this data. For the UAV route planning described herein, this can be useful for avoiding congested areas and/or times where traffic is heavy where a crash could impact large numbers of people or vehicles.

One or more of the third-party servers 114 may contain environmental data. This refers to data about air quality, pollution, ecological zones and the like. Environmental Protection Agency (EPA) databases or similar international platforms provide this data. For the UAV route planning described herein, this data can be used to avoid flying through areas with high pollution levels or sensitive environmental zones, reducing both operational risk and environmental impact.

One or more of the third-party servers 114 may contain emergency services data. This data includes the location and capacity of emergency services like fire stations, hospitals, and police stations, and the like. Local government databases can often provide this data. For the UAV route planning described herein, proximity to emergency services can be factored in to help with crash response planning, ensuring help is nearby if needed. For example, it may be beneficial to fly a UAV over or near emergency services, and avoid routes that stray too far from emergency services.

One or more of the third-party servers 114 may contain historical flight data. This data can include past flight paths, altitude, and patterns of manned and unmanned aircraft. Services like ADS-B Exchange or FlightRadar 24 store such data and can provide it. This can be valuable for predicting air traffic patterns and avoiding congested areas or airspaces where other flights are frequently operating.

One or more of the third-party servers 114 may contain communication infrastructure data. This data can include the locations of cell towers, satellite links, and other communication systems. Databases from telecom companies or government agencies like the Federal Communications Commission (FCC) can provide this. For the UAV route planning described herein, communication infrastructure can ensure continuous control and data transmission for UAVs, particularly during longer or more complex flights.

One or more of the third-party servers 114 may contain regulatory data. This can include national and local UAV regulations, including flight restrictions, permits, and operational guidelines. Regulatory data can be provided by the FAA or equivalent aviation authorities. For the UAV route planning described herein, this data can ensure that flight routes comply with all legal requirements, avoiding violations that could result in fines or operational bans.

One or more of the third-party servers 114 may contain real-time air traffic data. Real-time air traffic data can be provided by ADS-B receivers or services like FlightAware, for example. This can include real-time locations and movements of active aircraft in a specific airspace. For the UAV route planning described herein, real-time air traffic data can help with dynamic flight adjustments to avoid active aircraft, ensuring safe navigation in high-traffic areas.

One or more of the third-party servers 114 may contain electromagnetic interference (EMI) data. EMI data can be provided by spectrum regulators or telecom operators, for example. This can include information about regions with high levels of electromagnetic interference that could disrupt communication or control signals. For the UAV route planning described herein, EMI data can help with avoiding areas where communication signals may be unreliable, ensuring a safer and more stable operation.

One or more of the third-party servers 114 may contain obstruction data. Obstruction data can be provided by construction permit authorities or real-time traffic monitoring systems, for example. This can include information about temporary or mobile obstructions such as cranes, construction equipment, or other tall structures. For the UAV route planning described herein, obstruction data can help with avoiding temporary obstructions that may interfere with UAV flight paths, especially in urban or industrial areas.

One or more of the third-party servers 114 may contain power grid data. Power grid data can be provided by power companies or national utility databases, for example. This can include information about the location of power lines, substations, and other electrical infrastructure. For the UAV route planning described herein, power grid data can help with avoiding flights too close to high-voltage areas, reducing the risk of collisions and electrical interference.

One or more of the third-party servers 114 may contain geofencing data. Geofencing data can be provided by regulatory bodies or commercial geofencing services, for example. This can include predefined virtual boundaries that restrict UAV flights over certain areas, such as private properties or security-sensitive zones. For the UAV route planning described herein, geofencing data can help with ensuring compliance with flight restrictions and avoiding restricted zones, reducing the likelihood of legal violations.

One or more of the third-party servers 114 may contain noise pollution data. Noise pollution data can be provided by local government agencies or environmental authorities, for example. This can include data on areas where noise limits are enforced, such as near hospitals or schools. For the UAV route planning described herein, noise pollution data can help with avoiding areas where UAV noise may disturb sensitive environments or populations, ensuring quieter and more acceptable operations.

One or more of the third-party servers 114 may contain security data. Security data can be provided by defense departments or government agencies, for example. This can include information about security-sensitive areas such as military bases or government buildings. For the UAV route planning described herein, security data can help with avoiding restricted or sensitive security zones, ensuring compliance with national security protocols and preventing unintended incursions.

One or more of the third-party servers 114 may contain social activity data. Social activity data can be provided by social media platforms or local event databases, for example. This can include real-time information about large gatherings, such as sports games or parades. For example, increased social media activity can indicate a large population and real-time gathering of people at a particular event. For the UAV route planning described herein, social activity data can help with avoiding flights over highly populated areas during events, reducing the risk of accidents in crowded environments.

One or more of the third-party servers 114 may contain drone traffic management (UTM) data. UTM data can be provided by aviation authorities or UAV traffic control systems, for example. This can include data on other UAV operations in the same airspace. For the UAV route planning described herein, UTM data can help with safely coordinating flight paths with other drones, avoiding mid-air collisions and ensuring smoother traffic management in UAV-dense areas.

Each of the above types of data provided by third-party servers 114 can be generally referred to as location-based data, as it is associated with particular locations and thus can be filtered, sorted, and/or processed based on its location. Each of the above types of data can also be said to be provided by third-party entities 112, and can be stored in databases 116 and provided by associated servers 114 to the local server 110 via communication over the communication network 106.

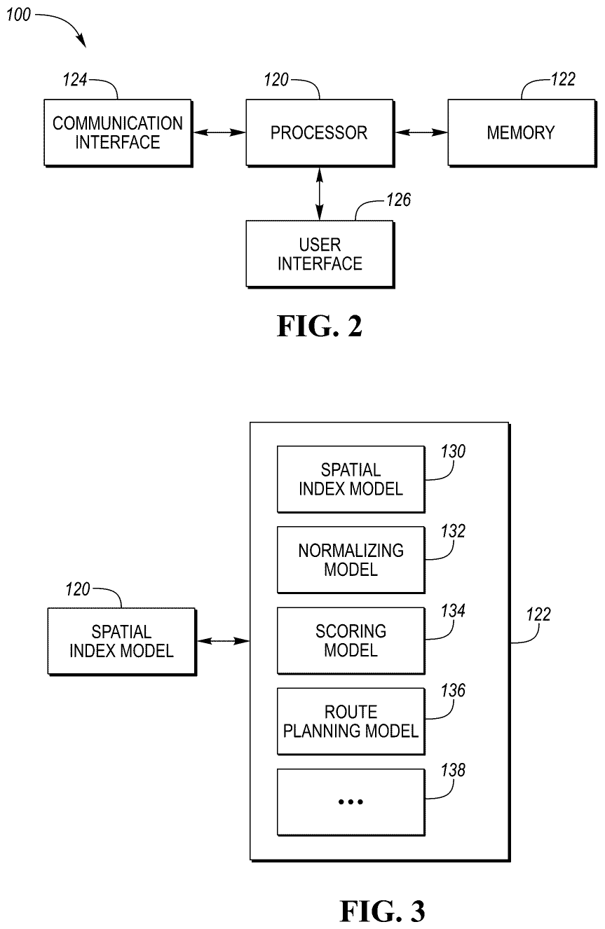

FIG. 2 illustrates a schematic block diagram of an example computing system/device 108 and/or example server 110. It should be understood that the discussion herein referencing the computing device 108 is equally applicable to the server 110 or other third-party server(s).

As shown, the computing device 108 may include a processor 120 in communication with a memory 122, a communication interface 124, and a user interface 126. The processor 120 serves as the central processing unit of the computing device 108. The processor 120 may receive information from the various components of the computing device 108 and may be configured to execute a plurality of instructions using the received information, as described further herein. The processor 120 can execute instructions stored in the memory 122, enabling the device to perform various computational tasks. These tasks include requesting and receiving the location-based data, normalizing the location-based data, assigning scores to spatial indices based on the normalized data, and the like as will further be outlined below.

The memory 122 stores the instructions and data necessary for the processor 120 to execute the processor's functions. The memory 122 may include various types of storage, such as volatile and non-volatile memory, to accommodate different data storage needs. This may include a non-volatile read-write memory which stores computer-executable instructions and data, and a volatile read-write memory (e.g., random access memory) that may be used as a working memory by processor 120. The memory 122 also holds the models and algorithms used for processing the data and generating the spatially-indexed scores described herein.

The communication interface 124 facilitates data exchange between the computing device 108 and external systems, including third-party servers 114 and UAVs 104. This interface supports various communication protocols, enabling seamless retrieval and transmission of location-based data. The communication interface 124 can ensure that the computing device 108 can access necessary data from third-party databases, such as population density, aeronautical information, and infrastructure details, which are important for UAV route planning. Through the communication interface 124, the computing device 108 can disseminate processed data to UAVs for route planning and execution. This interface can allow for real-time updates and adjustments to planned routes, ensuring that UAVs can navigate efficiently and safely. The communication interface 124 also can support connectivity with the flight management system 102, enabling coordinated operations and data sharing across all system components. The communication interface 124 can be designed to handle various types of networks, including wireless personal area networks, wireless local area networks, cellular networks, Ethernet, satellite communication networks, and the Internet. This versatility ensures robust and reliable communication, allowing the system to function effectively in diverse environments and conditions.

The user interface 126 provides a platform for interaction with the computing device 108, enabling users to input data, adjust parameters, and visualize outputs such as planned UAV routes and heat maps, for example. Structurally, the user interface 126 may include a display (e.g., monitor, screen, etc.) and an input device (e.g., mouse, keyboard, microphone, touch screen, etc.). The user interface 126 allows users to define specific inputs and filter data, facilitating the refinement of proposed routes based on scores generated by the system. The user interface 126 supports a customizable and interactive experience, allowing users to manipulate data and parameters to achieve optimal route planning for UAV operations. Through the user interface 126, users can engage with a heat map visualization, where each segment or cell of the map is assigned a score reflecting the risk associated with that area. This visualization aids in interpreting complex data sets, providing a clear representation of risk factors across different regions. Users can interact with the heat map to explore various routing scenarios, adjusting scores and inputs to tailor the route planning process to specific needs and preferences. The user interface 126 also supports real-time updates and adjustments, ensuring that users can respond to changing conditions and data inputs. This dynamic capability enhances the system's flexibility, allowing for continuous optimization of UAV routes. By providing a comprehensive and user-friendly interface, the system ensures that users can effectively manage and plan UAV operations, leveraging the integrated data and scoring mechanisms to navigate complex environments safely and efficiently.

FIG. 3 illustrates a schematic of models stored in memory 122 and executed by processor 120. The processor 120 serves as the central processing unit, interfacing with the memory 122 to execute a series of models designed to facilitate UAV route planning and risk assessment. These models can include, for example, spatial index model 130, normalizing model 132, scoring model 134, route planning model 136, and other models configured to perform the various functions disclosed herein. These models can be machine learning models, neural networks, algorithms, or the like that are designed to perform specific tasks by recognizing patterns and making decisions based on input data.

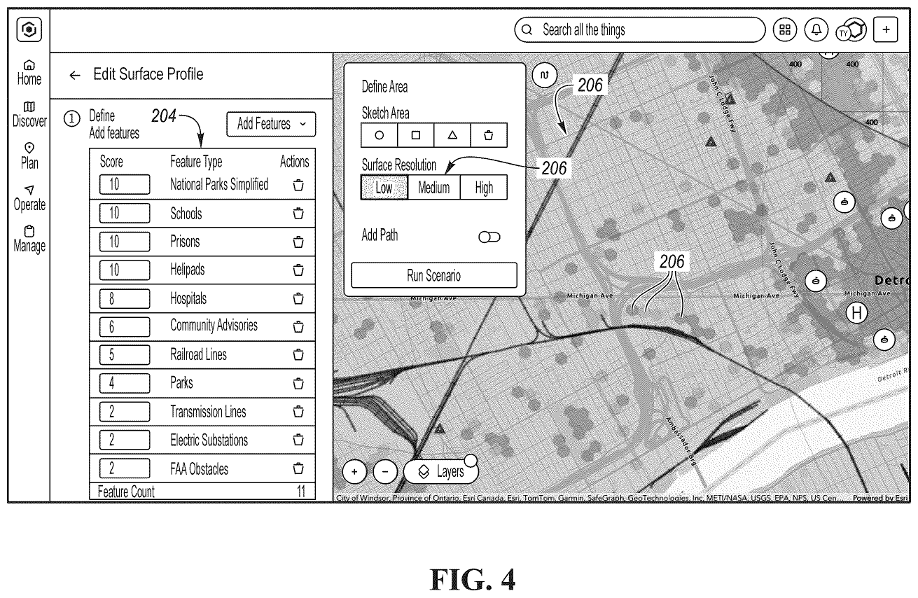

The spatial index model 130 is responsible for performing spatial indexing functions. This includes, for example, dividing geospatial data into smaller, manageable units or “spatial indices” that represent specific geometric boundaries within the area of interest. This model could be a rule-based algorithm that takes the coordinates of the area and breaks it into polygons (such as grids or cells) that each correspond to a spatial index. Each cell can be in the shape of a hexagon, triangle, or other similar shape. Alternative to, or in combination with, the rule-based algorithm, the spatial index model 130 can use a machine learning approach that adapts to different terrains or geographic features. The model 130 assigns each spatial index a unique identifier and ensures that the UAV's operational area is covered by these discrete, non-overlapping regions. The performance of this model 130 is configured for organizing data spatially and providing a framework upon which other models can operate. As will be described further herein, FIG. 4 shows an example of a map with various spatial indices, each of which being produced via the spatial index model 130.

Returning to FIG. 3, the normalizing model 132 can be configured to take in location-based data retrieved from the third-party databases and convert it into a common format that can be consistently processed. This model can use algorithms to map disparate data types, such as different units of measurement, formats, or even types of data (e.g., raster vs. vector data), into a uniform representation. A machine learning normalizing model might be trained on historical datasets, learning how to transform data from various sources into the desired format. This model 132 is configured for ensuring that all data, regardless of source or structure, is compatible for analysis by subsequent models in the system (e.g., scoring model 134), allowing for seamless integration of diverse data types.

In an embodiment, the normalizing model 132 operates as follows. Before normalization, data cleaning can occur to ensure that the data is complete and accurate. This involves handling missing values, removing duplicates, and correcting inconsistencies. For example, if a population dataset has some missing entries for specific geographic areas, the model would either fill these gaps through interpolation or flag them for review. After cleaning, the system can standardize the formats. For example, numerical data from different sources might use various units of measurement (e.g., kilometers vs. miles, Celsius vs. Fahrenheit). A normalization model can convert all of these units into a common standard. Similarly, geographic data can be converted into the same coordinate system (e.g., WGS84 or UTM), ensuring that location-based information can be easily compared. Different datasets might also contain data in incompatible types (e.g., strings, integers, floats). The normalizing model can ensure that all data is converted into a common type where appropriate. For example, date and time data from different sources might be stored in varying formats (YYYY/MM/DD, DD/MM/YYYY, etc.), and the model would reformat them into a uniform structure. Similarly, categorical data (such as zoning designations) could be mapped into a consistent set of codes or labels. Data might also vary in terms of scale. For instance, population density data may be expressed as individuals per square kilometer, while infrastructure data might be on a larger or smaller geographic scale. To normalize this, the system can convert all spatial data to a common grid size or spatial index (as mentioned earlier). This step ensures that every dataset is aligned geographically, allowing for direct comparisons and combinations of data types over the same spatial regions. If the data includes mixed types (e.g., continuous data like weather measurements and categorical data like zoning information), the normalization model can convert everything into a numerical format. For categorical data, this might involve one-hot encoding (representing each category as a binary vector) or assigning numerical risk scores. Once the normalization process is complete, the disparate data sources would all be transformed into a unified structure, such as a relational database or a GIS-compatible dataset. This data could then be used by the scoring model 134, allowing it to work with a homogenous dataset where all inputs—whether geographic, demographic, environmental, or infrastructural—are in a comparable format.

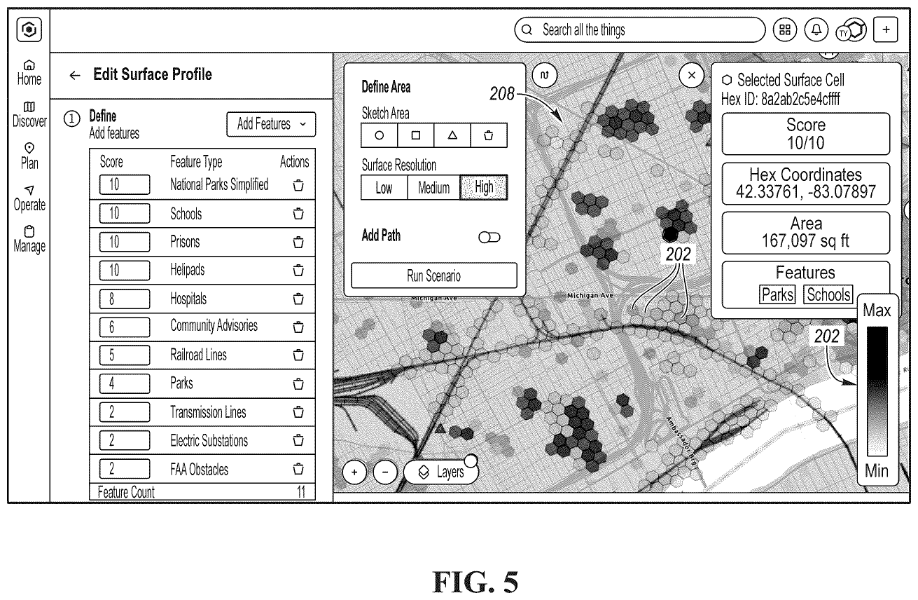

The scoring model 134 is configured to analyze the normalized data and assign a risk score to each spatial index. The scoring model 134 can be a neural network trained on a dataset of historical UAV flight data, crashes, and near-miss incidents. The scoring model 134 can be a neural network trained on the location-based data to output a score indicating the risk associated with flying a UAV over the location associated with the indices, with the score being based on real flight data or user feedback from a human user informing the model 134 whether the scores should be higher or lower based on the various location-based data associated with the indices. The scoring model 134 can analyze the normalized location-based data like population density, weather conditions, and proximity to infrastructure to determine the risk associated with flying through each index. Alternatively, it can be a rules-based model that uses weighted factors to calculate scores based on predefined criteria. For example, a higher population density or unfavorable weather would increase the risk score. These rules can be input and pre-defined by the user. The scoring model's output allows for determining how safe or risky it is for a UAV to fly through a particular region, and it forms the foundation for route optimization in later steps. As will be described further herein, FIGS. 5-7 show scores being assigned to the various spatial indices, and these scores can be output by the scoring model 134.

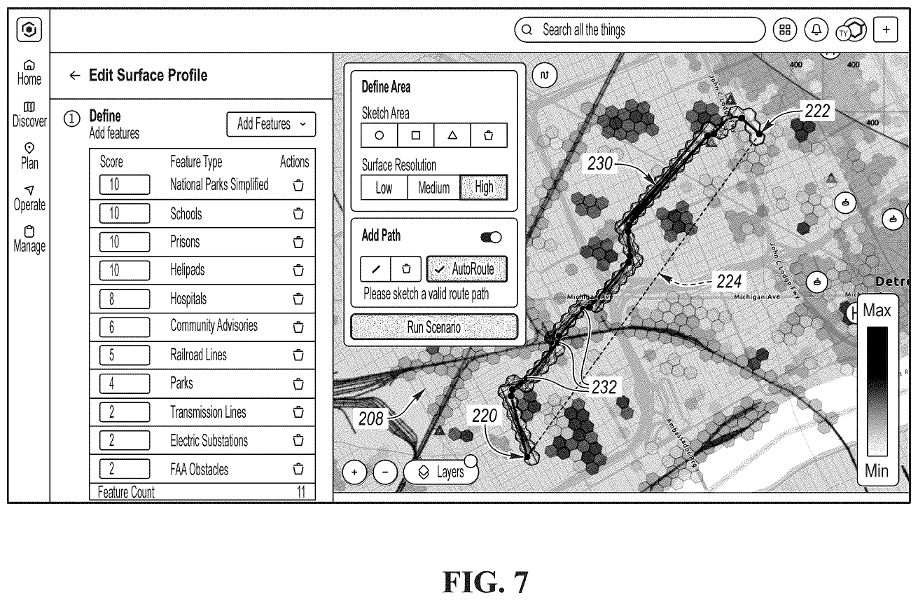

The route planning model 136 is configured to use the risk scores generated by the scoring model to output an optimal flight path for the UAV. This model could employ pathfinding algorithms like Dijkstra's or A* to identify the safest, most efficient route through the spatial indices with the lowest scores. Alternatively, the route planning model 136 can utilize a reinforcement learning-based model to learn over time by simulating thousands of routes and adjusting its planning to minimize risks and travel time. The route planning model integrates the spatial index data, risk scores, and potentially other variables such as the UAV's battery life or regulatory constraints to generate a flight route that avoids high-risk areas. As is described further herein, FIG. 7 shows a proposed route for the UAV to take, and that proposed route is output by the route planning model 136.

FIGS. 4-7 illustrate various examples of user interfaces suitable for UAV applications, using system 100, according to embodiments. These user interfaces can be generated and displayed via user interface 126, for example. In the illustrated embodiment, the images shown in FIGS. 4-7 are examples of how the user interface would appear on-screen to a user during various steps along the way of generating a proposed route for the UAV. The illustrated user interfaces can be generated by the computing device 108, the server 110, or the like. For example, the processor can be 120 can be configured to execute graphical rendering software to visually represent the user interface on a screen for a user to view.

FIG. 4 is an example of a user interface showing a map of a certain area, in this case southwest Detroit. The location can be any location provided by the user of the system. The shown location can be generated for display based on the received geospatial data associated with the location. The geospatial data can be received by one or more third-party servers 114 as explained above. The user can move the cursor around and select other locations to be shown on the display.

A map 200 is displayed based on the geospatial data. The spatial index model 130 can segregate the geospatial data into spatial indices 202. The spatial indices 202 can be regular, evenly-shaped grid cells. In the illustrated embodiment, the spatial indices 202 are hexagonal in shape, but can also be triangular, rectangular, or other. Hexagonal indices have been shown to provide superior segregation of the map, but this disclosure is not limited to such a shape. Each spatial index 202 can be selected by the user so that more information of each index can be viewed. For example, the various location-based data associated with the location of each index can be retrieved and shown to the user.

Also shown in the user interface of FIG. 4 is a filter 204. The filter 204 provides the user with the ability to select which of the location-based data should be analyzed for route planning. Here, eleven different features (e.g., “schools”, “prisons”, etc.) are shown based on the location-based data received from third-party servers. Each feature has an associated score (e.g., on a scale of 1-10). The score can indicate the risk of flying a UAV in a cell having one or more of the features. The user can alter the score of each of the location-based data field, or these can be automatically generated based on the models described herein.

Also shown in the user interface of FIG. 4 is a surface resolution option 206. The surface resolution option 206 allows the user to alter the resolution (e.g., size of the surface indices). Currently, the “Low” resolution option is selected. For example, each surface index is roughly the size of two or three city blocks. However, if the user were to select the “Medium” or “High” resolution option, the size of the spatial indices would decrease in size, giving the system the ability to plan routes with even more accuracy based on a more micro analysis of the location-based data. This can lead to planned routes that have even more accuracy and precision.

FIG. 5 illustrates the user interface now showing additional spatial indices 202 after processing the geospatial data. Each spatial index with a physical location or space. And, as shown in this image, each spatial index is assigned a risk score based on the processing of the location-based data. In other words, the normalizing model 132 has normalized the location-based data, and the scoring model 134 has output a score for each spatial index. As discussed above, the score can be associated with the risk of flying the UAV in the location associated with that spatial index.

The score output by the scoring model 134 may be a numerical value (e.g., on a scale from 1-10) or the like. In embodiments, these scores can be visually represented on the user interface by color or shading. For example, the color of each spatial index can change according to its score. This provides a heat map 208 that can be overlaid onto the map created and shown in FIG. 4. A heat map legend 210 can be shown, indicating a legend as to what the colors mean. In this embodiment, “min” or “minimum” means that the spatial indices shaded this color should try to not be flown over by the UAV—they are higher risk. Likewise, “max” or “maximum” means the system should bias the flight route toward these spatial indices, as there is a lower risk of flying in the areas associated with these indices. Spatial indices that are not shaded or not visible can be due to either there not being enough data associated with that location, or the risk being below a threshold such that no shading is necessary at all, and the route of the UAV can be biased to travel through these areas.

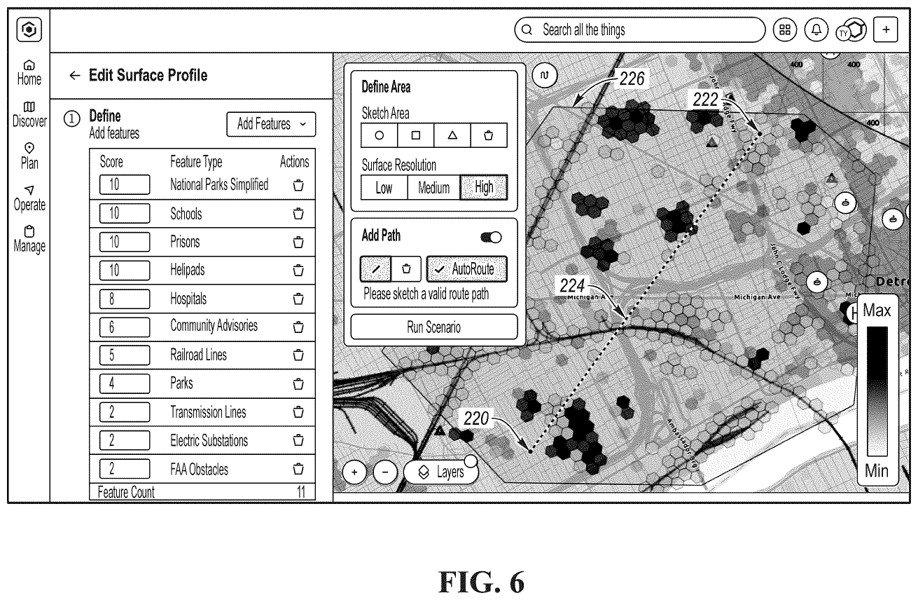

FIGS. 6-7 show execution of the route planning model 136 based on the scores output by the scoring model 134, according to an embodiment. In FIG. 6, a user has selected a starting point 220 and an ending point 222. The starting point 220 represents a location where the UAV will depart from, which could be a shipping warehouse, UAV facility, or the like. The ending point 222 can represent a destination for the UAV, such as a home or business where a parcel is to be delivered. The user using the user interface can manually input these locations by entering in the addresses, or can select a geographical location on the map by pointing and clicking. Other options are available and the present disclosure is not limited to the methods of inputting the starting point 220 and ending point 222.

A line 224 is shown connecting the starting point 220 to the ending point 222. This line represents the shortest distance between the two points 220, 222. If flight risk were not taken into consideration by the system 100, the UAV may very well take this flight route to perform the intended task of flying from the starting point 220 to the ending point 222. However, due to potential risks involved in flying this route, the system 100 works to create a safe route for the UAV taking into considering the risks of the locations associated with the spatial indices. For example, note the spatial indices that intersect with line 224 that have a relative degree of risk.

Also shown in this Figure is a boundary 226. This boundary represents a geographical area that the UAV should not exit during the flight from the starting location 220 to the ending location 222. This boundary can be automatically generated based on the location-based data. For example, if a state or country boundary is located nearby, the boundary 226 can contain the UAV to fly within just that state or country so that it is not traveling interstate or international. The automatic generation of the boundary can also be based on a determined or predefined distance away from the line 224 and/or the starting and ending points 220, 222 to assure the UAV does not veer too far away from the line 224, which might cause an inefficient route taken by the UAV.

The route planning model 136 then generates a planned route 230 for the UAV that takes into consideration the scores of each spatial index 202 and the boundary 226. An example of a generated planned route 230 is shown in FIG. 7. Here, the planned route 230 deviates from the line 224 to avoid higher-risk locations based on the scores of the spatial indices 202. The planned route 230 can have a number of nodes 232 with straight lines connecting each node 232, each node representing a change in direction to be taken by the UAV.

Subsequent to this planned route 230 being generated, the user interface can provide an option for the user to select or approve this planned route as the route for the UAV to take.

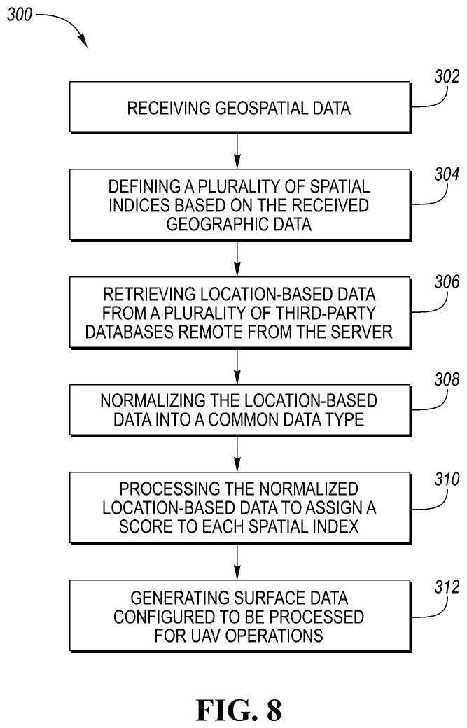

FIG. 8 illustrates a schematic flow chart of a computer-implemented method 300 for generating spatially-indexed scores suitable for UAV applications, according to an embodiment. The method can be executed via computing device 108, server 110, processor 120 executing instructions stored in memory 122, or the like.

At 302, geospatial data, mapping data, geographic data, Geographic Information System (GIS) data, or the like is received. This data can be received at the server 110 or computing device 108, and can be provided by a third-party server 114 or database 116 as described above. The data can be associated with a selectable location. For example, the selectable location may be the location that is currently visible on a screen of a user interface. Alternatively, the selectable location may be the location that is at, near, or within a radius of the starting point or other selected point that the user selects for the route to be taken by the UAV.

At 304, spatial indices 202 are defined. These spatial indices 202 are exemplified in FIGS. 4-7, and are associated with a respective geometric boundary based on the received geospatial data. As described earlier, these spatial indices can be a grid of hexagonal (or other shaped) cells, with each cell corresponding to a portion of physical location from the geospatial data. Spatial index model 130 can be executed to perform this function.

At 306, location-based data is retrieved from a plurality of third-party sources 112, such as servers 114 and/or databases 116. The location-based data can be transmitted to the computing device 108 or server 110 via network 106. This location-based data can include characteristics or qualities of the physical area of each spatial index. Many forms of third-party data exists, and it can include things like aviation data, population data, land usage data, zoning data, facility data, infrastructure data, natural data, and building data. Some or all of this available third-party data can be retrieved so it can be processed locally by the computing device 108 and/or server 110.

This type of data can be disparate, i.e., data that is stored in separate systems, databases, or file formats, and that is not designed to be compatible or integrated with each other. Therefore, at 308, the system normalizes the location-based data into a common data type. Normalizing model 132 can be used for this function, as described above. For example, the normalizing model 132 can perform cleaning, converting, and aligning disparate data from different sources into a consistent format, ensuring that all data is uniform in structure, units, and type for seamless analysis in subsequent models in the system 100.

At 310, the normalized data is then processed to so that a score can be assigned to each spatial index. Each score reflects a weighted risk factor associated with directing a UAV through that spatial index. This function can be performed by the scoring model 134, as explained above.

Then, at 312, surface data can be generated. This surface data is configured to be processed for UAV operations, and includes the scores associated with each spatial index. The surface data generated can be a comprehensive, processed dataset that represents various risk factors, conditions, and relevant geographic information for UAV route planning. It can resemble a layered map or grid of spatial indices, with each assigned a specific score based on factors such as population density, airspace restrictions, weather, infrastructure, and other risk variables. These scores would indicate the level of risk or suitability for UAV flight through each region. Visually, surface data could be represented as a heatmap, where each spatial index is color-coded according to its risk score, with high-risk areas shown in red, moderate-risk areas in yellow, and low-risk areas in green. Although this is not required. The surface data may be all of the data necessary to create the heatmap, allowing other third parties to process the data as they see fit. This surface data could include the geospatial data, layered in a GIS platform or delivered as a dataset in formats compatible with UAV navigation software. A third party, such as a client, could use the surface data to integrate into their own UAV operations system to plan safe and efficient routes. By overlaying real-time information such as air traffic or weather updates on top of this surface data, they can dynamically adjust UAV flight paths to avoid high-risk areas, ensuring compliance with safety regulations and minimizing the potential for accidents. The surface data provides a decision-making framework that allows clients to direct UAVs through the safest, most optimal routes based on the pre-analyzed and scored geographic indices.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A computer-implemented method for generating spatially-indexed scores suitable for Unmanned Aerial Vehicle (UAV) applications, the method comprising:
at a server, receiving geospatial data associated with a selectable location;
defining a plurality of spatial indices, wherein each spatial index is associated with a respective geometric boundary based on the received geospatial data;
retrieving location-based data from a plurality of third-party databases remote from the server, wherein the location-based data is associated with the location and includes one or more of aviation data, population data, land usage data, zoning data, facility data, infrastructure data, natural data, and building data associated with at least a portion of the location;
at the server, normalizing the retrieved location-based data into a common data type;
at the server, processing the normalized location-based data to assign a score to each spatial index, wherein each score reflects a weighted risk factor associated with directing a UAV through that spatial index; and
at the server, generating surface data configured to be processed for UAV operations, wherein the surface data includes the scores associated with each spatial index.

2. The computer-implemented method of claim 1, further comprising:
generating a planned route for a UAV based on the surface data and the scores associated with each spatial index.

3. The computer-implemented method of claim 2, further comprising:
sending instructions to the UAV, wherein the instructions cause the UAV to travel along or within proximity of the planned route.

4. The computer-implemented method of claim 2, further comprising:
classifying each spatial index according to its respective score, wherein the planned route is generated based on the classification of each spatial index.

5. The computer-implemented method of claim 1, further comprising:
filtering which of the location-based data is normalized and processed to assign the scores of the spatial indices.

6. The computer-implemented method of claim 5, further comprising:
adjusting the scores based on which of the location-based data is selected via the filtering, and
adjusting a planned route of a UAV based on the adjusted scores.

7. The computer-implemented method of claim 1, further comprising:
dynamically adjusting a resolution of the spatial indices; and
assigning the scores based on the adjusted resolution of the spatial indices.

8. The computer-implemented method of claim 1, wherein the score is on a scale such that a high score is associated with a higher risk of travel for the UAV, and a low score is associated with a lower risk of travel for the UAV.

9. The computer-implemented method of claim 1, further comprising:
generating, for display on a user interface, a planned route for the UAV based on the surface data and the scores associated with each spatial index.

10. The computer-implemented method of claim 9, further comprising:
generating, on a user interface, a contiguous surface map associated with the scores of each spatial index, wherein the surface map includes a visual representation of the score of each spatial index.

11. The computer-implemented method of claim 10, further comprising:
generating a map for display on the user interface based on the received map data; and
overlaying the surface map and the planned route onto the generated map for display on the user interface.

12. A system for generating spatially-indexed scores suitable for Unmanned Aerial Vehicle (UAV) applications, the system comprising:
a user interface;
a local server commutatively connected to the user interface and configured to communicate with third-party servers via a communication network, wherein the third-party servers are remote from the local server and store location-based data, wherein the local server includes a processor and memory storing instructions that cause the processor to:
receive a selection of a location from a user via the user interface;
obtain geospatial data associated with the location;
define a plurality of spatial indices, wherein each spatial index is associated with a respective geometric boundary based on the received geospatial data;
retrieve the location-based data from the third-party servers, wherein the location-based data is associated with the location and includes one or more of aviation data, population data, land usage data, zoning data, facility data, infrastructure data, natural data, and building data associated with at least a portion of the location;
normalize the retrieved location-based data into a common data type;
assign a score to each spatial index based on the normalized location-based data, wherein each score reflects a weighted risk factor associated with directing a UAV through that spatial index based on the normalized location-based data; and
generate surface data configured to be processed for UAV operations, wherein the surface data includes the scores associated with each spatial index.

13. The system of claim 12, wherein the memory stores instructions that further cause the processor to:
generate a planned route for a UAV based on the surface data and the scores associated with each spatial index.

14. The system of claim 13, wherein the memory stores instructions that further cause the processor to:
send instructions to the UAV to cause the UAV to travel along or within proximity of the planned route.

15. The system of claim 13, wherein the memory stores instructions that further cause the processor to:
classify each spatial index according to its respective score, wherein the planned route is generated based on the classification of each spatial index.

16. The system of claim 12, wherein the memory stores instructions that further cause the processor to:
receive filtering instructions from the user interface; and
based on the filtering instructions, filter which of the location-based data is normalized and processed to assign the scores of the spatial indices.

17. The system of claim 16, wherein the memory stores instructions that further cause the processor to:
adjust the scores based on which of the location-based data is selected via the filtering, and
adjust a planned route of the UAV based on the adjusted scores.

18. The system of claim 12, wherein the memory stores instructions that further cause the processor to:
receive a request from the user interface to adjust a resolution of the spatial indices;
dynamically adjust the resolution in response to the request; and
assign the scores based on the adjusted resolution.

19. The system of claim 12, wherein each spatial index is hexagonal in shape.

20. A computer-implemented method for controlling Unmanned Aerial Vehicles (UAVs), the method comprising:
receiving geospatial data associated with a selectable location;
defining a plurality of spatial indices, wherein each spatial index is associated with a respective geometric boundary based on the received geospatial data;
retrieving location-based data from a plurality of third-party databases remote from the server, wherein the location-based data is associated with the location and includes three or more of aviation data, population data, land usage data, zoning data, facility data, infrastructure data, natural data, and building data associated with at least a portion of the location;
normalizing the retrieved location-based data;
assigning a score to each spatial index based on the normalized location-based data, wherein each score reflects a weighted risk factor associated with directing a UAV through that spatial index;
generating surface data configured to be processed for UAV operations, wherein the surface data includes the scores associated with each spatial index; and
sending the surface data to a third party to enable the third party to control a UAV based on the surface data.
